(19) United States
(12) Patent Application Publication
(10) Pub. No.: US 2010/0019123 A1
(43) Pub. Date: Jan. 28, 2010

(54) MODULAR LAYOUT FORM FOR EMBEDDING OBJECTS IN A SETTABLE MATERIAL

(75) Inventor: Samuel C. Scott, Denver, CO (US)

Correspondence Address: DORR, CARSON & BIRNEY, P.C.;ONE CHERRY CENTER, 501 SOUTH CHERRY STREET, SUITE 800, DENVER, CO, 80246, US

(73) Assignee: SCOTT SYSTEM, INC., Denver, CO (US)

(21) Appl. No.: 12/180,919

(22) Filed: Jul. 28, 2008

(51) Int. Cl. B28B 7/22

(52) U.S. Cl. 249/13

(57) ABSTRACT

A modular layout form has a substantially planar rear for attachment to a support structure, and a substantially planar front having a two-dimensional array of receptacles for holding objects to be embedded in a predetermined pattern in a settable material (e.g., concrete). The form includes a plurality of courses staggered with respect to one another to define a pattern of recesses and protrusions at the ends of the courses. Sets of tabs and slots on the recesses and protrusions can be used to engage complementary tabs and slots on the recesses and protrusions of an adjacent form, so that a plurality of forms can be combined by sliding adjacent forms together laterally in a common plane.

### BACKGROUND OF THE INVENTION

Field of the Invention. The present invention relates generally to the field of forms used in the construction industry for embedding a pattern of objects (e.g., bricks) in a settable material, such as concrete. More specifically, the present invention discloses a modular layout form that can be readily combined with other similar modular forms to create an assembly of any desired size for embedding a pattern of objects in a settable material.

Statement of the Problem. Simulated brick construction has become increasingly common in construction of modern buildings and other concrete structures. With the scarcity of skilled workers today, the cost of fabricating a true brick or masonry wall has become a significant concern. To address these problems, many construction companies have turned to simulated brick building panels that are backed by concrete to form a wall or structure having a simulated brick exterior appearance. This type of construction has a major shortcoming in that the panels can be difficult to handle and position at the construction site, particularly when dealing with large building panels. Examples of the prior art in the field of such building panels include U.S. Pat. No. 4,644,719 (Salazar), U.S. Pat. No. 6,138,423 (Poutanen et al.), U.S. Pat. No. 3,701,228 (Taylor) and U.S. Pat. No. 4,076,875 (Van Gasse).

Another approach uses brackets or retainers for holding a pattern of bricks, tiles or similar objects that are fastened to the inside surface of a concrete wall form. When concrete is poured into the form, it flows around the exposed surfaces of the bricks, which become embedded in the concrete. After the concrete sets, the concrete wall form and brackets are disassembled and removed. This results in a structure in which the bricks are embedded in the outer surface of the wall. The prior art in this field includes the Applicant's U.S. Pat. Nos. 5,922,235, 6,186,469 and 5,667,190 (Scott et al.). These patents show a bracket for holding an individual brick tile. A number of brackets can be clipped together in any of a variety of arrangements and fastened to the inside surface of a concrete wall form to create an assembly for holding a corresponding number of bricks. However, this approach can require considerable labor to assemble a large form.

Another type of retainer shown in the prior art uses a liner or mat deployed in a horizontal position. These retainers are usually made from an elastomeric material and have a two-dimensional pattern of receptacles. Each receptacle is shaped to closely fit the outside perimeter of one of the bricks to be held in place. Examples of the prior art in this field include U.S. Pat. No. 5,900,180 (Scott et al.) and U.S. Pat. No. 3,602,476 (Iragorri). This type of retainer is typically arranged in a horizontal position because it lacks a positive device for securely holding the bricks in position. Concrete is poured over the bricks and retainer in a horizontal form. After the concrete has set, the resulting panel can be removed and installed in any desired orientation in the construction project. These liners or mats have a number of shortcomings. Most importantly, they are not generally suitable for use on the vertical walls of concrete forms, which means they cannot be used to form a vertical wall or structure in place. Individual panels must be moved and assembled after forming, which limits their size and commonly results in visible seams or lines between the assembled panels.

Solution to the Problem. The present invention addresses the shortcomings of the prior art by providing a modular form having receptacles for holding a plurality of bricks in a predetermined pattern that can be attached to the vertical wall of a concrete form. The receptacles in the forms are arranged in staggered courses similar to conventional patterns in bricklaying, which results in the lateral edges of each form having a pattern of half-brick recesses and protrusions. The lateral edges are also equipped with sets of tabs and slots that enable adjacent forms to be connected.

Multiple forms can be combined to create a larger pattern of any desired size in either of two ways. First, adjacent forms can be aligned so that their protrusions abut and their recesses abut, and then locking holders are dropped into the abutting recesses of adjacent forms. In other words, each drop-in locking holder fills in two half-brick recesses between adjacent forms in this configuration. Second, adjacent forms can slide together laterally in a common plane so that the protrusions on an end of the form slidingly engaging complementary recesses on an end of an adjacent form. In this configuration, the sets of tabs and slots on the recesses and protrusions engage complementary tabs and slots on the recesses and protrusions of an adjacent form.

### SUMMARY OF THE INVENTION

This invention provides a modular layout form having a planar front with a two-dimensional array of receptacles for holding objects to be embedded in a predetermined pattern in a settable material (e.g., concrete). The form includes a plurality of courses staggered with respect to one another to define a pattern of recesses and protrusions at the ends of the courses. Sets of tabs and slots on the recesses and protrusions can be used to engage complementary tabs and slots on the recesses and protrusions of an adjacent form, so that a plurality of forms can be combined by sliding adjacent forms together laterally in a common plane. Alternatively, adjacent forms can be aligned so that their protrusions abut and their recesses abut, and then locking holders are dropped into the abutting recesses.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a perspective view of a modular layout form.

FIG. 2 is a front elevational view of the form in FIG. 1.

FIG. 3 is a rear elevational view of the form in FIG. 1.

FIG. 4 is a bottom view of the form in FIG. 1.

FIG. 4a is a detail bottom view of a portion of the modular layout form in FIG. 4.

FIG. 5 is a top view of the form in FIG. 1.

FIG. 5a is a detail top view of a portion of the modular layout form in FIG. 5.

FIG. 6 is a left side elevational view of the form in FIG. 1.

FIG. 6a is a detail left side elevational view of a portion of the modular layout form in FIG. 6.

FIG. 7 is a right side elevational view of the form in FIG. 1.

FIG. 7a is a detail right side elevational view of a portion of the modular layout form in FIG. 7.

FIG. 8 is a front elevational view of a plurality of forms assembled in a first configuration using locking holders 40.

FIG. 8a is a front elevational view of a plurality of forms assembled in a second configuration.

FIG. 9 is an exploded front elevational view corresponding to the assembly configuration shown in FIG. 8.

FIG. 10 is a detail front elevational view of the lower portion of the first assembly configuration shown in FIG. 8.

FIG. 10a is a cross-sectional view showing a locking holder 40 being inserted into place between two adjacent forms.

FIG. 11 is a front elevational view of a locking holder 40.

FIG. 11a is a bottom view of the locking holder 40 shown in FIG. 11.

FIG. 11b is a top view of the locking holder 40 shown in FIG. 11.

FIG. 11c is a right side view of the locking holder 40 shown in FIG. 11.

FIG. 11d is a left side view of the locking holder 40 shown in FIG. 11.

FIG. 12 is a rear elevational view of the locking holder 40 shown in FIG. 11.

FIG. 13 is a front elevational view of a locking holder 40 for holding a half brick.

FIG. 13a is a bottom view of the locking holder 40 shown in FIG. 13.

FIG. 13b is a top view of the locking holder 40 shown in FIG. 13.

FIG. 13c is a right side view of the locking holder 40 shown in FIG. 13.

FIG. 13d is a left side view of the locking holder 40 shown in FIG. 13.

FIG. 13e is a rear elevational view of the locking holder 40 shown in FIG. 13.

FIG. 14 is a detail perspective view of a brick 50 being placed into one of the receptacles 11 of a form 10.

FIG. 15 is a cross-sectional view of an assembled form with a concrete wall 55 and embedded bricks 50.

FIG. 16 is another cross-sectional view of the assembled form and wall shown in FIG. 15.

FIG. 16a is a detail cross-sectional view of the bead between two adjacent bricks 50 in FIG. 16.

FIG. 17 is a perspective view showing the form assembly being removed from a finished wall.

FIG. 18 is a front perspective view of another embodiment of a modular layout form 10 using an elastomeric rim 13 in each receptacle 11 for holding bricks.

FIG. 19 is a detail perspective view of a brick 50 being inserted into one of the receptacles 11 of the form 10 shown in FIG. 18.

FIG. 20 is a detail cross-sectional view of a brick 50 being inserted into one of the receptacles 11 of the form 10 shown in FIG. 18.

FIG. 21 is a detail cross-sectional view of an assembled form and wall using the embodiment of the form in FIG. 18.

FIG. 22 is a perspective view showing the form assembly in FIG. 21 being removed from a finished wall.

### DETAILED DESCRIPTION OF THE INVENTION

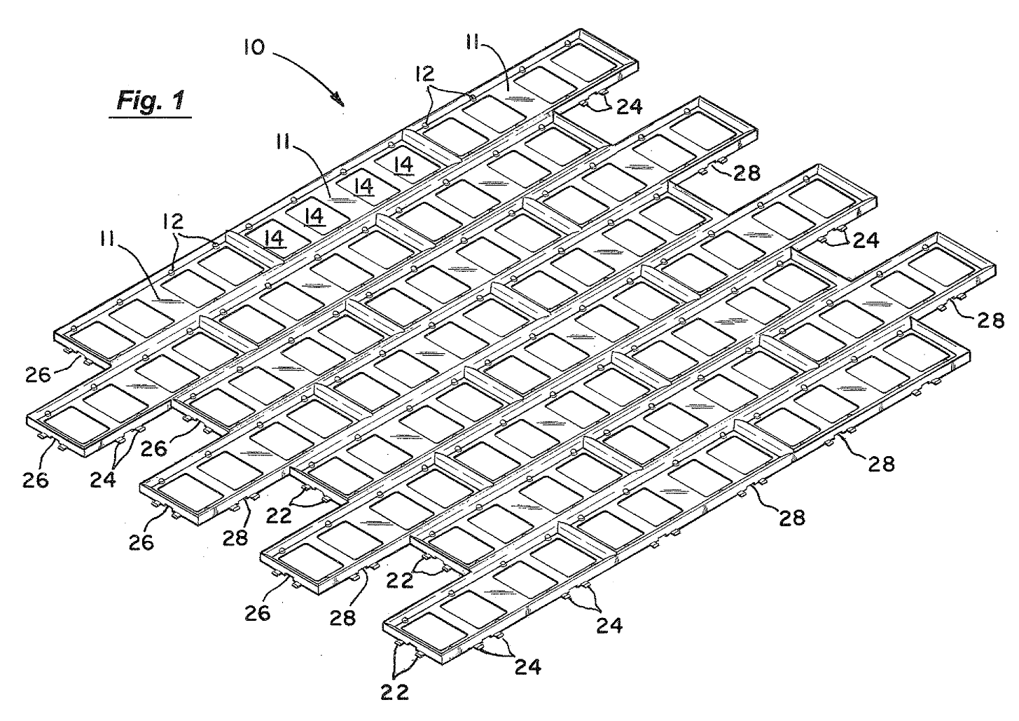

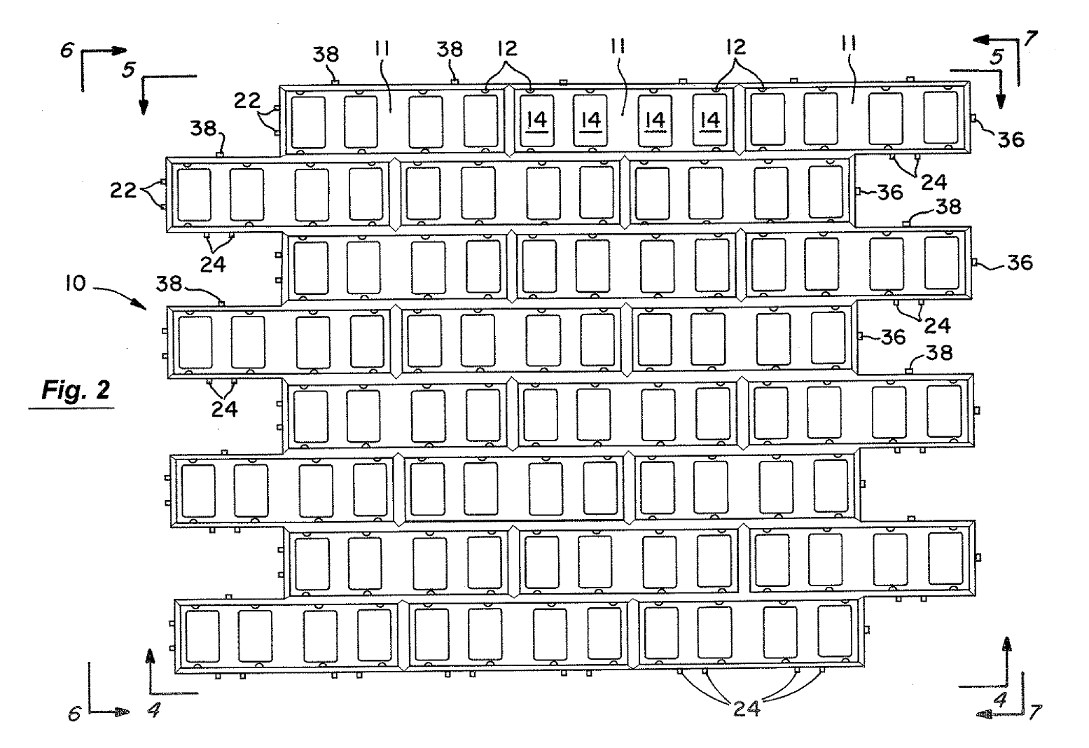

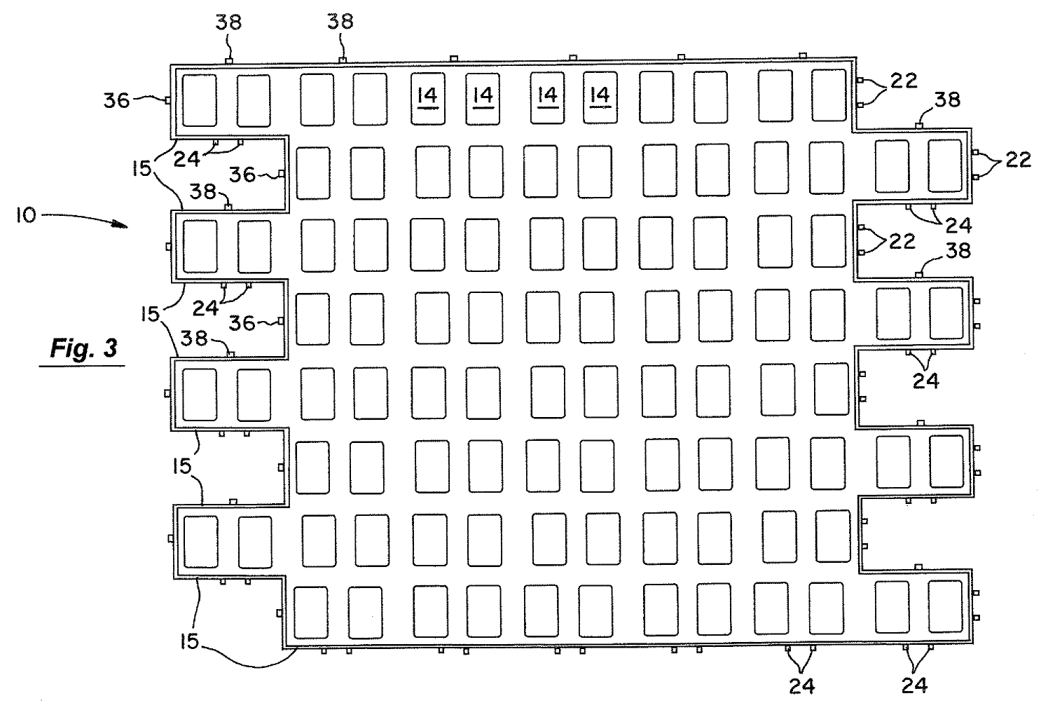

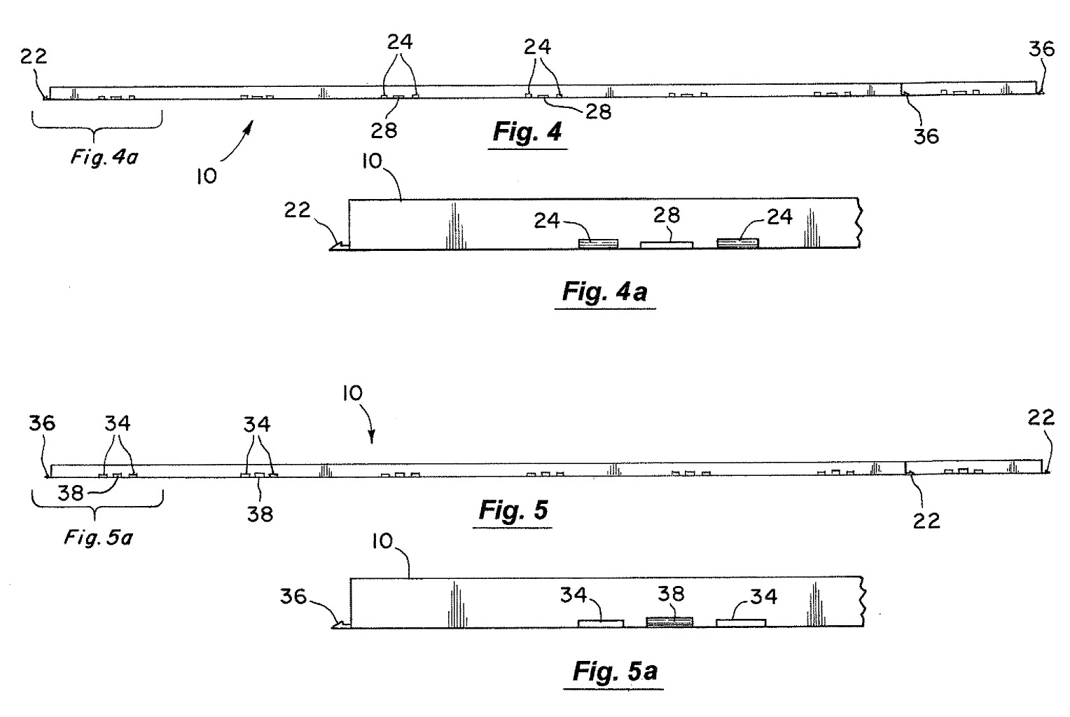

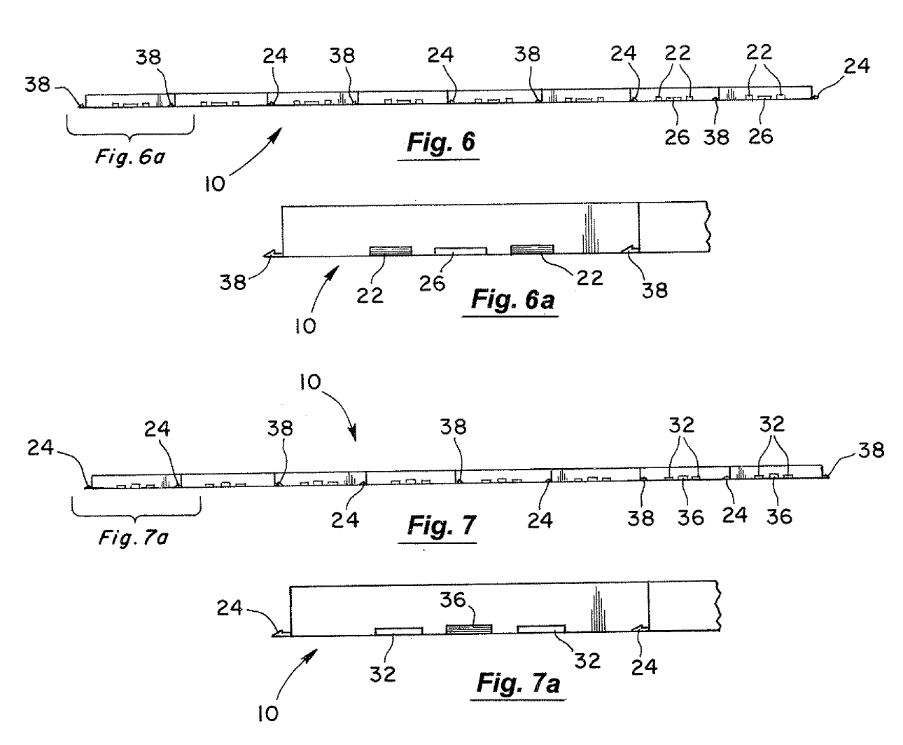

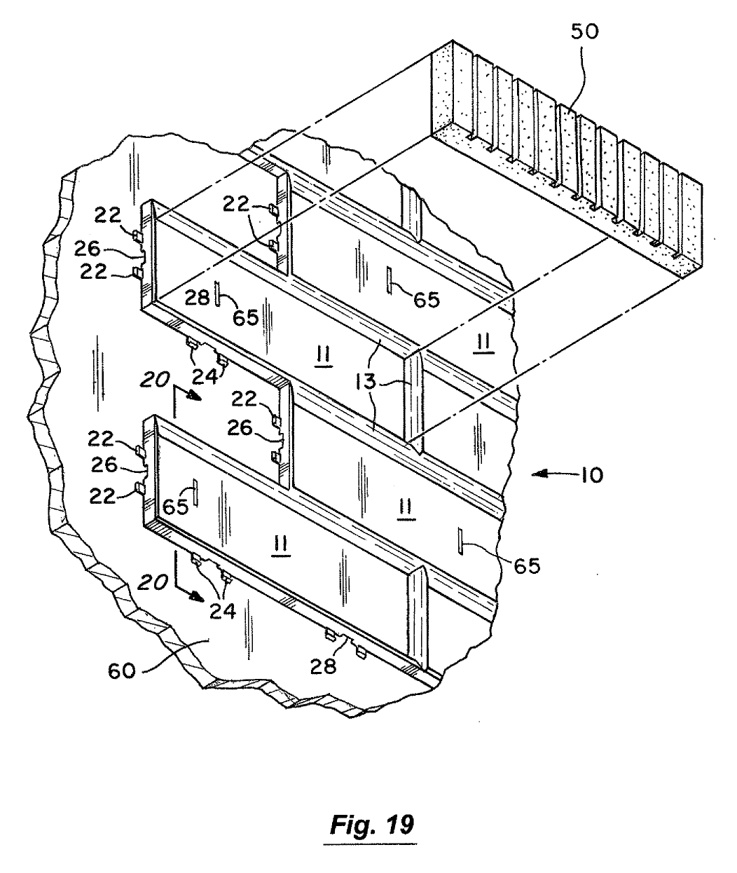

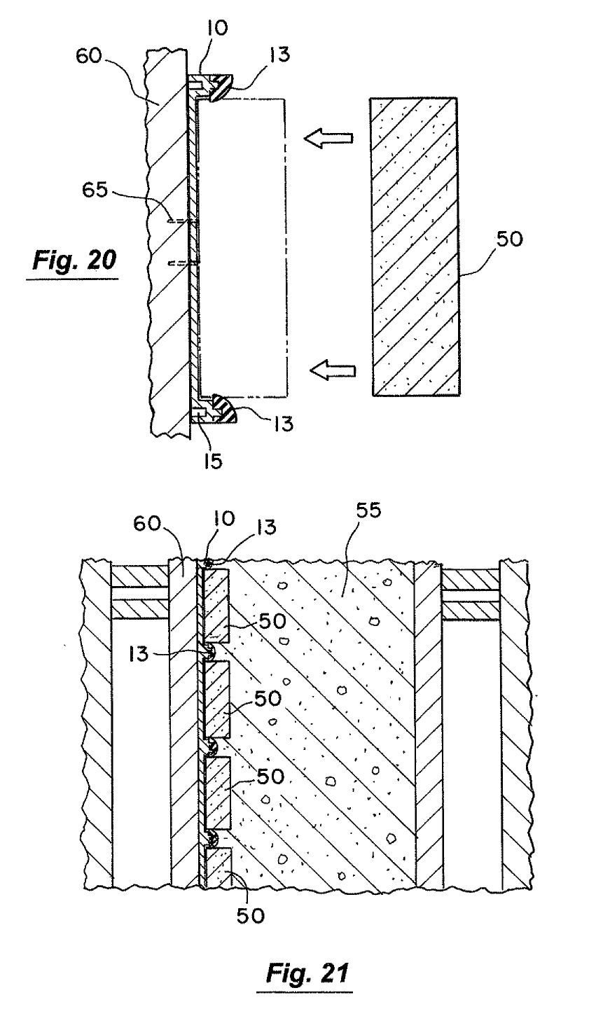

Turning to FIG. 1, a perspective view is shown of a modular layout form 10 embodying the present invention. Corresponding front and rear elevational views of the form 10 are provided in FIGS. 2 and 3, respectively. FIG. 4 is a bottom view and FIG. 5 is a top view of this form. Left and right side elevational views of the form are illustrated in FIGS. 6 and 7, respectively. As shown in these drawings, the form 10 has a substantially planar rear for attachment to a support structure, such as a concrete wall form. The form 10 also has a substantially planar front with a two-dimensional array of receptacles 11 for holding a plurality of objects (e.g., bricks or tiles) in a predetermined pattern. For example, the form 10 can be molded out of a suitable plastic to provide a degree of flexibility and resilience. The rear surface of the form 10 can be a thin layer of plastic that allows the form 10 to be stapled 65 to a concrete wall form 60, as depicted in FIGS. 19 and 20. A number of windows 14 can be created in this rear surface to reduce weight and cost, as shown in FIGS. 1-3.

The embodiment shown in FIG. 1 implements a conventional running bond for bricks, in which each course of receptacles 11 is staggered with respect to adjacent courses by about one half brick. This results in the lateral edges of the form 10 having an alternating pattern of recesses and protrusions at the ends of the courses. It should be expressly understood that other bonds or other patterns of construction objects could be readily substituted to create lateral edges with virtually any suitable recurring pattern of recesses and protrusions.

Each of the receptacles 11 in the front of the form 10 is generally intended to hold a single construction object. The embodiment shown in the accompanying drawings is designed to hold rectangular bricks, which result in substantially horizontal edges on the recesses and protrusions, but other object shapes (e.g., hexagonal, octagonal or round) could be substituted. The perimeter of each receptacle 11 serves to form the grout line or grouted area between objects in the finished wall. Each receptacle 11 can also be equipped with a number of clips 12 extending into the receptacle 11 from its perimeter for holding bricks in the receptacles as disclosed in detail in U.S. Pat. No. 5,667,190 (Scott et al.).

Returning to FIGS. 1-3 and the detail side elevational views provided in FIGS. 4a, 5a, 6a and 7a, it should be noted that the horizontal and vertical edges of the form 10 are equipped with sets of tabs and slots for engaging complementary slots and tabs on adjacent forms. The particular embodiment shown in these figures uses two tabs and one slot on the lower horizontal edges and left vertical edges of the form 10. In contrast, there are one tab and two slots on the upper horizontal edges and right vertical edges of the form 10. Other combinations or arrangements of complementary tabs and slots could be employed. Preferably, the slots and tabs are in the plane of the form and adjacent to the rear of the form 10

Horizontal channels 15 can be provided on the rear surface of the form 10 adjacent to the horizontal edges of each protrusion, as shown in the rear view of FIG. 3. These channels 15 enable the protrusions to slide over the tabs 22, 24 extending from the horizontal edges of the recesses of an adjacent form, as will be described below.

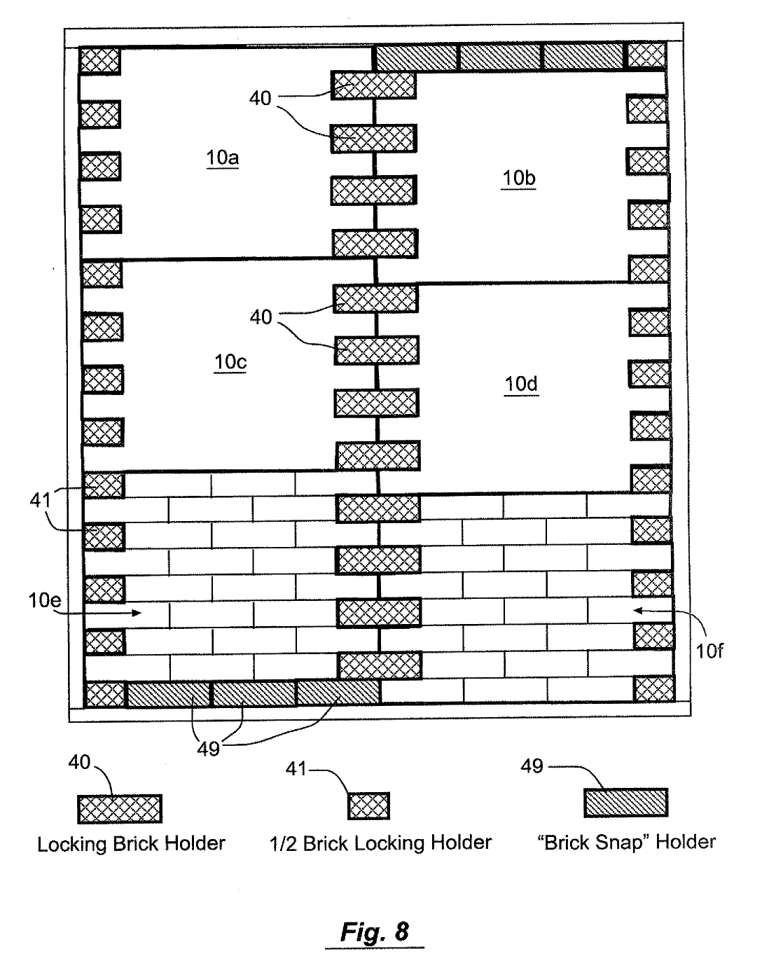

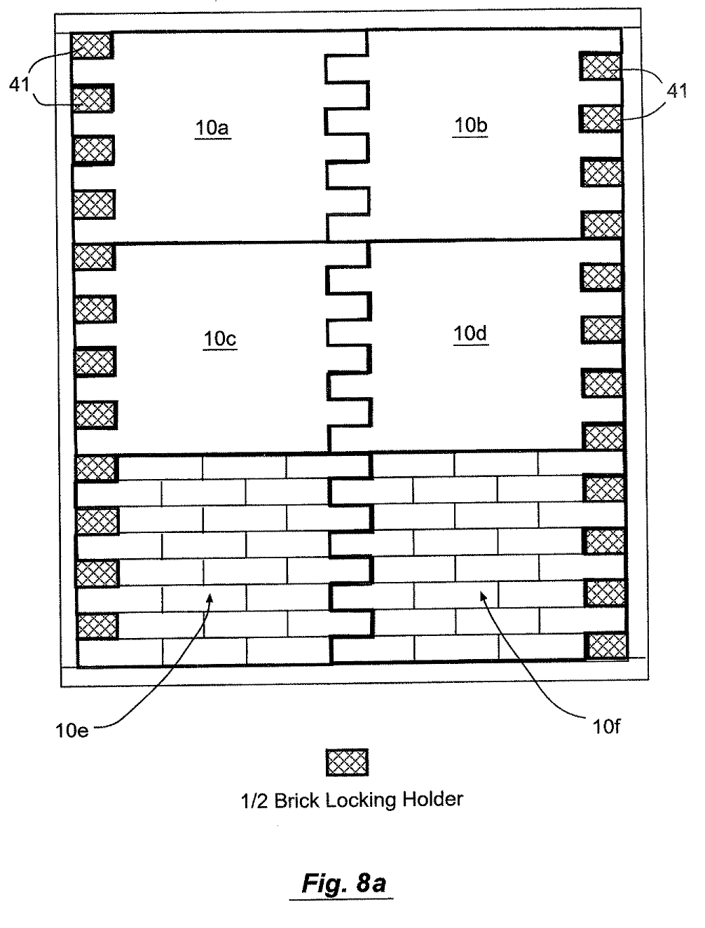

The following is a discussion of the ways in which these forms can be combined. Forms can be stacked vertically simply by sliding the lower horizontal edge of one form against the upper horizontal edge of a second form, so that tabs 24 on the first form engage slots 34 (shown in FIGS. 5 and 5a) on the second form, and tab 38 on the second form engages slot 28 (shown in FIGS. 1, 4, and 4a). Any desired number of forms can be stacked vertically in this manner to achieve a required height, as shown for example in FIGS. 8 and 8a.

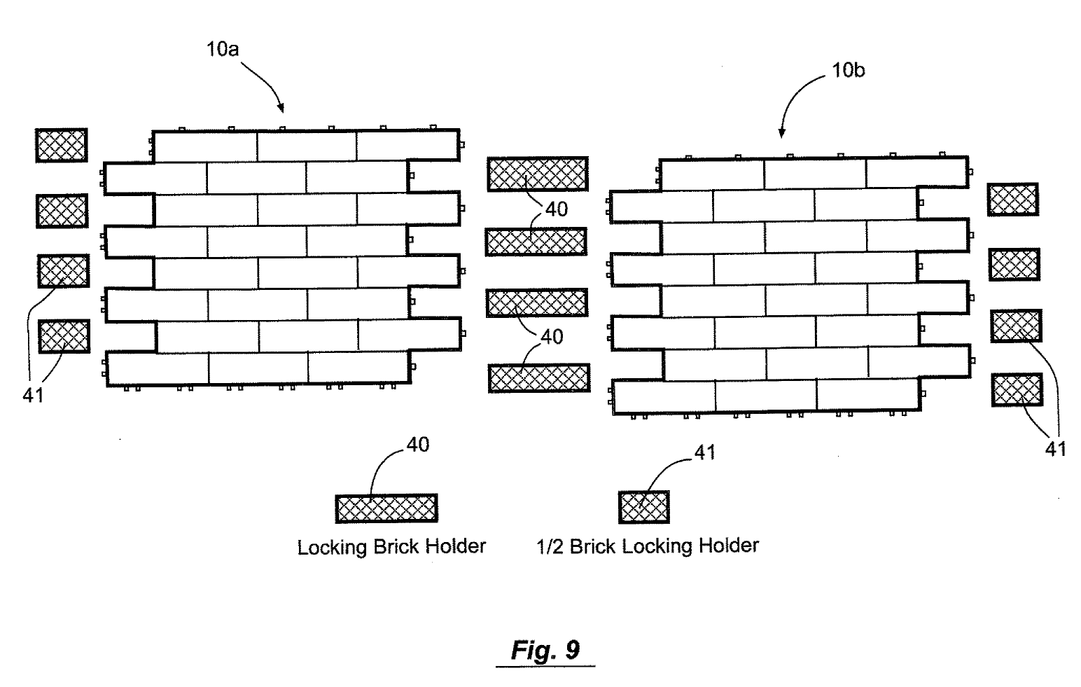

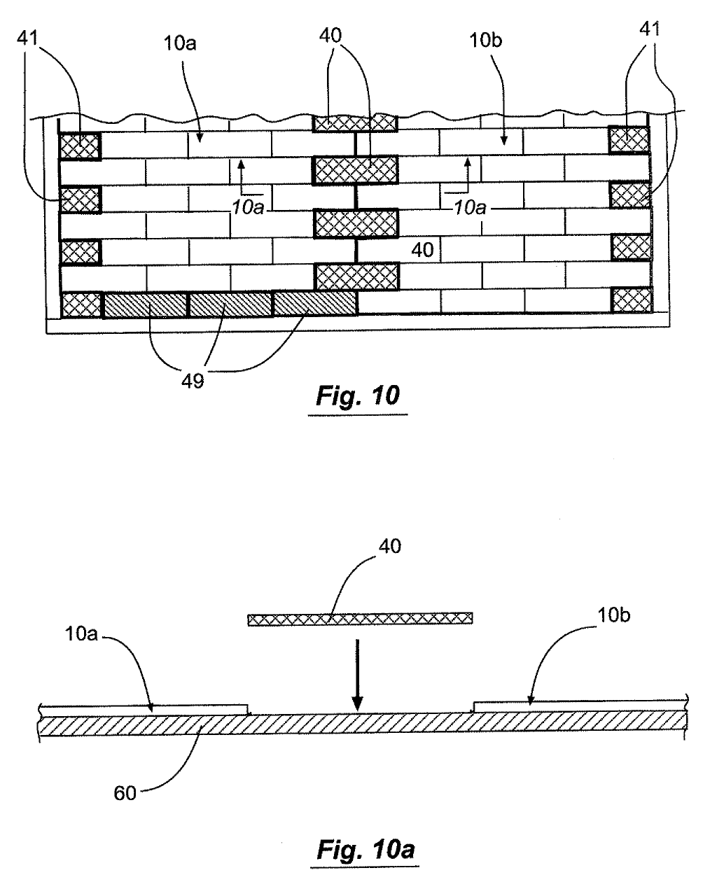

Forms can be combined horizontally (or laterally) in either of two ways. The first configuration is illustrated in FIGS. 8, 9, 10 and 10a. Here, adjacent forms (e.g. forms 10a and 10b) are placed in lateral abutment with their protrusions laterally aligned and their recesses laterally aligned. The aligned recesses create a void in the resulting pattern. A locking holder 40 is then inserted into the aligned recesses to secure the adjacent forms to one another and complete the pattern of construction objects, as shown in FIG. 8. The locking holders 40 can be dropped into the plane of the forms 10a, 10b, etc. from the front as shown in FIG. 10a, and then stapled to the support structure 60 (e.g., a concrete wall form).

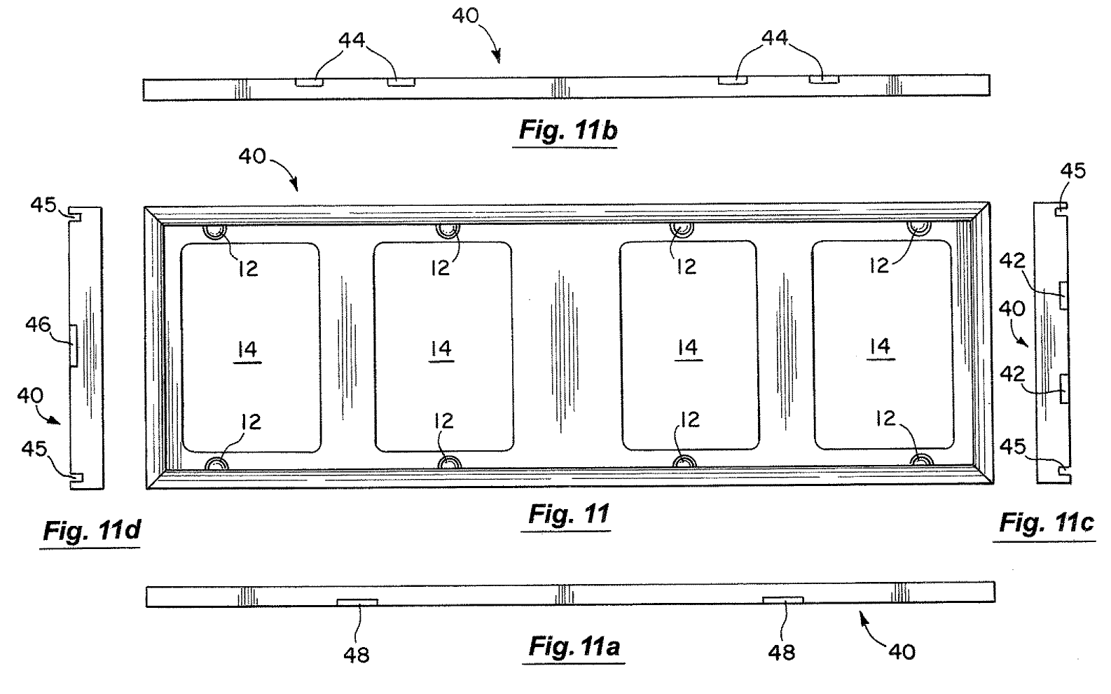

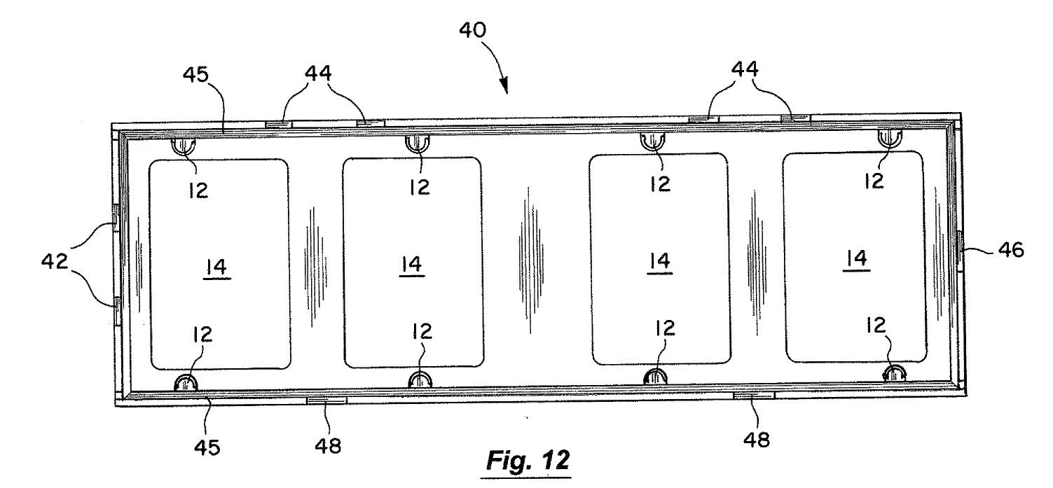

FIGS. 11-12 provide the orthogonal views for one embodiment of a locking holder 40. This locking holder 40 has a substantially planar rear and a substantially planar front with a receptacle for holding an object (e.g., a brick or tile). The locking holder 40 also has slots 42, 44, 46 and 48 (shown in FIGS. 11a-11d and 12) adjacent to the rear of the locking holder 40 to engage the tabs 22, 24, 36 and 38 extending into the aligned recesses of the adjacent forms. The perimeter of the locking holder 40 and its receptacle are designed to continue the pattern of objects created by the forms 10a, 10b, etc. with virtually no visible seams in the finished wall. As shown in the front and rear elevational views in provided in FIGS. 11 and 12, the locking holder 40 can include clips 12 extending inward from the perimeter of its receptacle to hold a brick. The locking holder 40 can also include horizontal channels 45 on its rear surface to enable to slide over the tabs 22, 24 extending from the horizontal edges of the recess of a form 10.

One minor drawback associated with this first configuration is that laterally-adjacent forms (e.g., forms 10a and 10b) will be one course out of vertical alignment as shown in FIGS. 8 and 10. This results in voids along the top and bottom of the assembly as shown in FIG. 8, which can be filled with a series of individual “Brick Snap” brackets of the kind disclosed in U.S. Pat. Nos. 5,922,235 and 5,667,190 (Scott et al.) that are each suitable for holding a single brick.

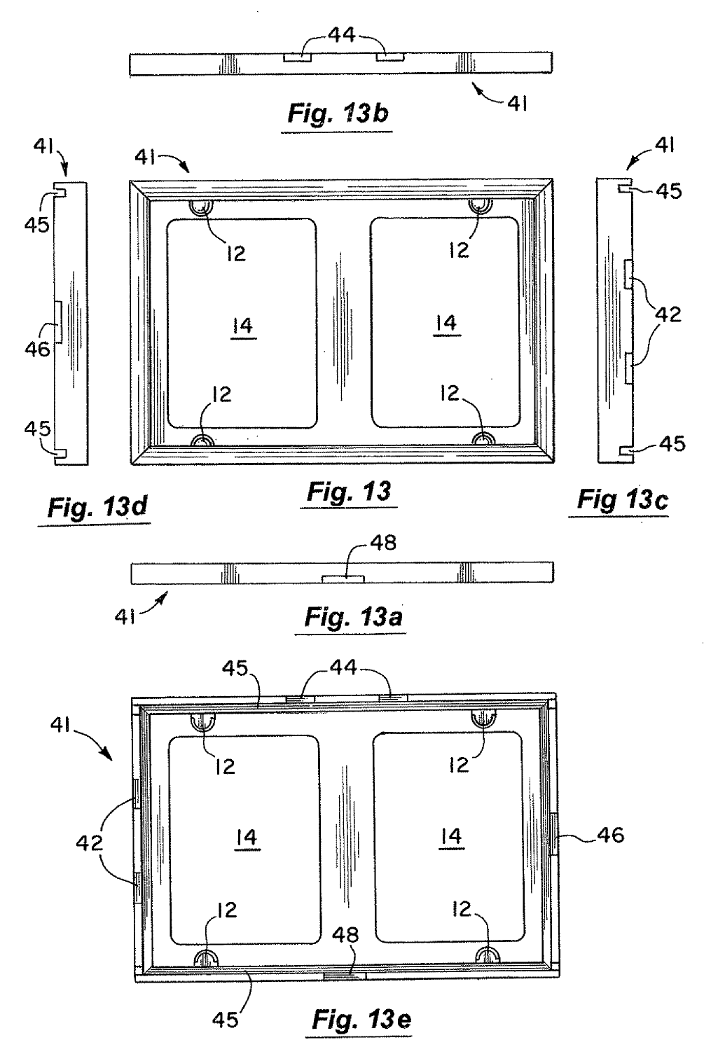

Similarly, the recesses at the lateral ends of the forms 10a-10f can be filled with half-brick brackets 41. The half-brick bracket 41 has a receptacle suitable for holding a half brick. FIGS. 13-13e show the orthogonal views for an embodiment of a half-brick bracket 41. Here again, the half-brick bracket 41 is equipped with sets of slots 42, 44, 46 and 48 about its outer periphery to engage complementary tabs 22, 24, 36 and 38 extending into the recess.

The second way in which adjacent forms can be horizontally combined is illustrated in FIG. 8a. In this second configuration, laterally-adjacent forms (e.g., forms 10a and 10b, 10c and 10d, and 10e and 10f in FIG. 8a) slide directly together in an interlocking relationship in a common plane. The protrusions on the end of a form slidingly engage complementary recesses on the end of an adjacent form in an interdigital manner. Note the locking holders 40 used in the first configuration are omitted in this second configuration.

In particular, at the left edge of a form, the tabs 22 on the vertical edges of the protrusions and recesses engage the slots 32 in the vertical edges of the recesses and protrusions of an adjacent form. At the right edge of a form, the tab 36 on the vertical edges of the protrusions and recesses engage the slot 26 in the vertical edges of the recesses and protrusions of an adjacent form. The tabs 24, 38 on the horizontal edges of the recesses slide along the horizontal channels 15 on the underside of the protrusions, and then register in slots 28 and 34.

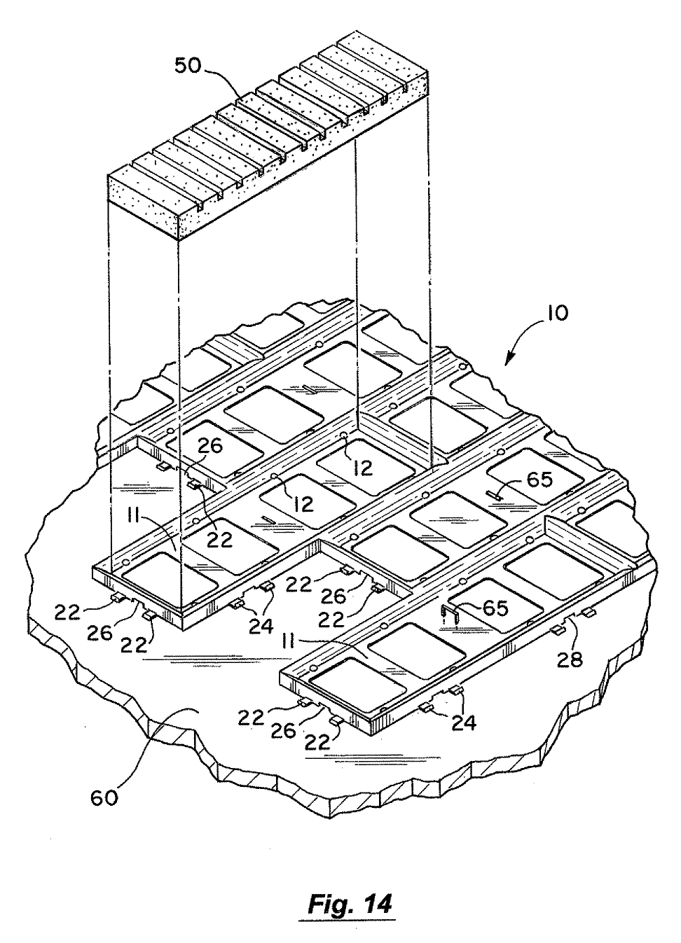

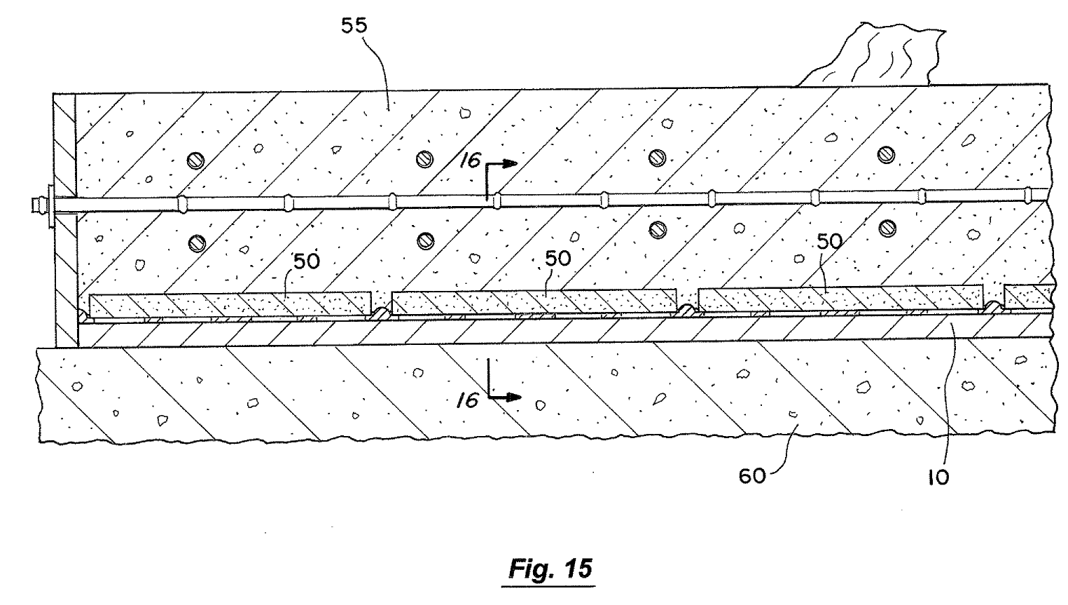

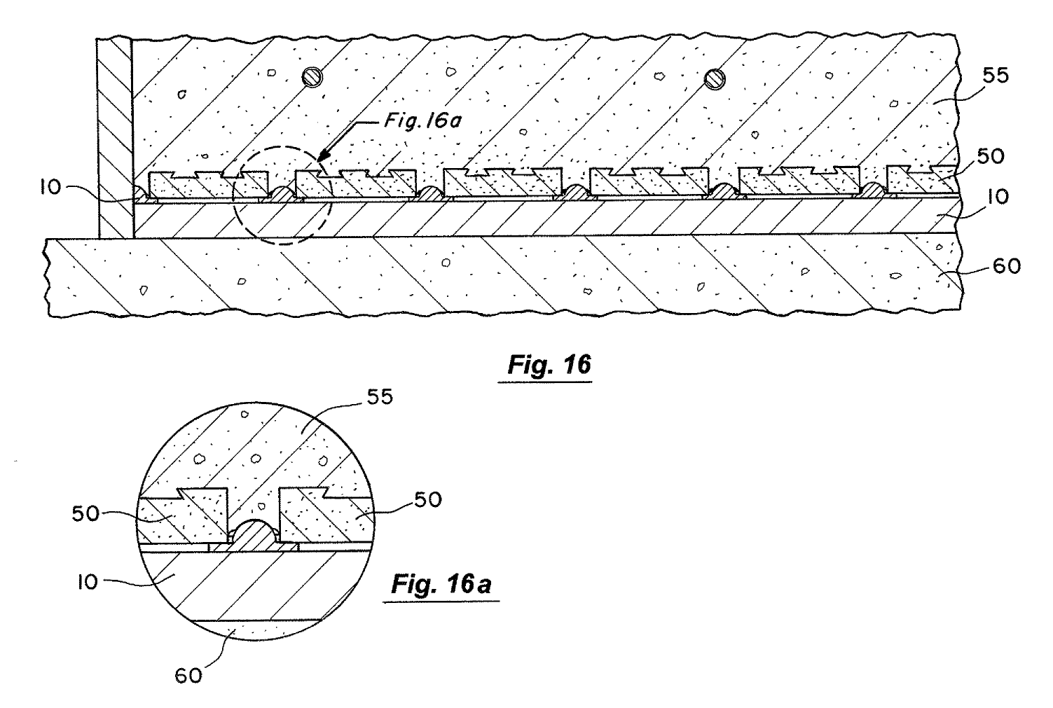

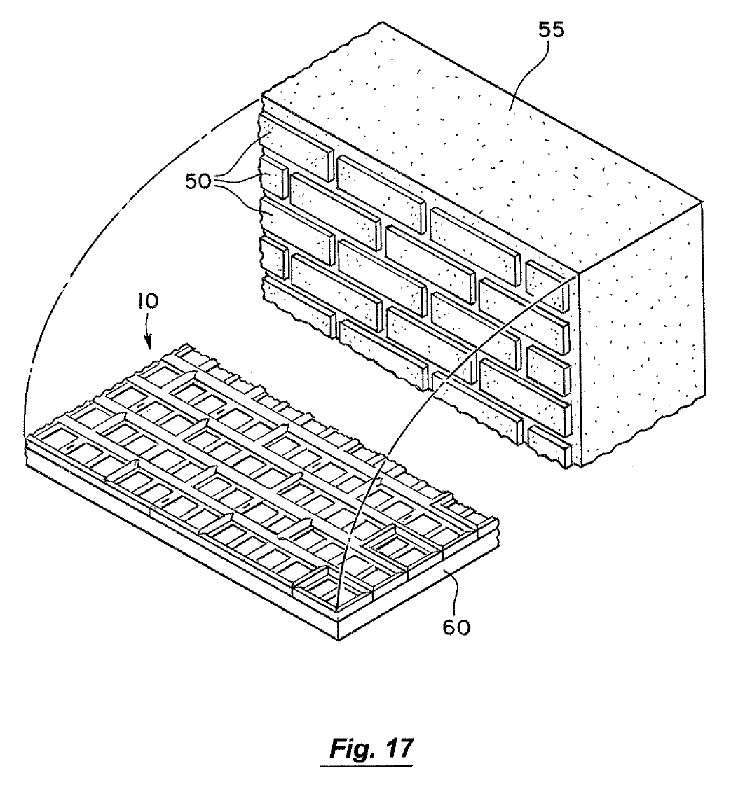

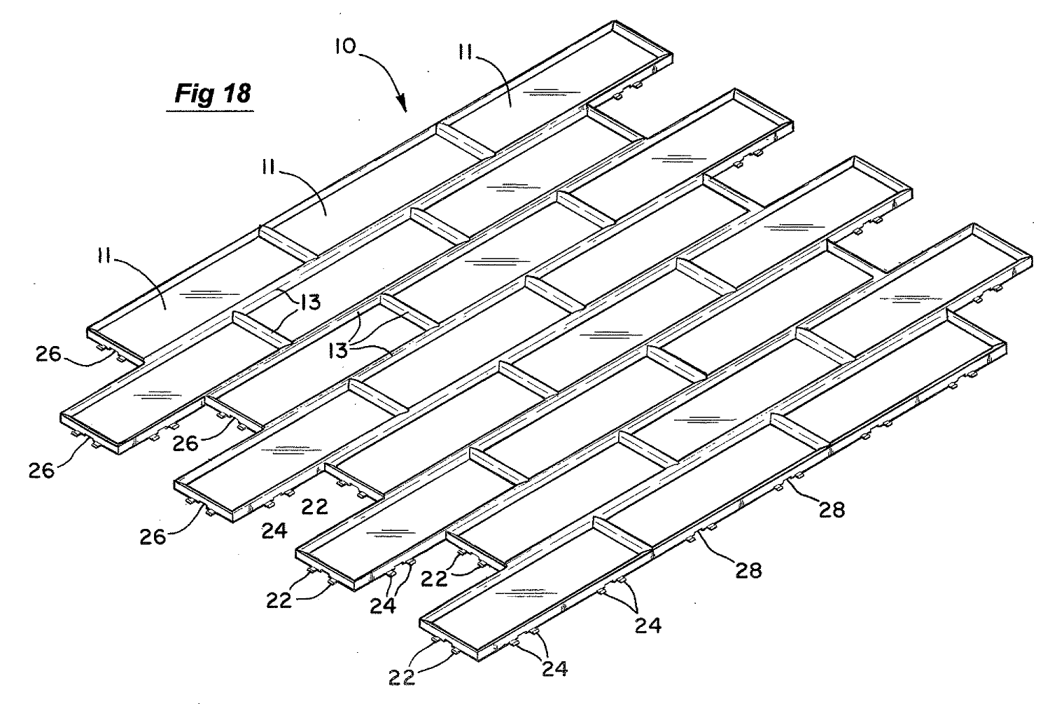

FIGS. 14 through 17 illustrates the steps in using the present invention to create a wall or similar structure after a set of forms has been assembled and secured to a supporting structure 60. Bricks are first placed in all of the receptacles 11 of the forms 10 are depicted in FIG. 14. Concrete 55 is then poured into the form assembly, so that the bricks 50 become embedded in the concrete. The concrete 55 is allowed to set. FIG. 15 is a cross-sectional view of an assembled form with a concrete wall 55 and embedded bricks 50. FIG. 16 is another cross-sectional view of the assembled form and concrete wall 55. FIG. 16a is a detail cross-sectional view of the bead or grout line between two adjacent bricks 50 in FIG. 16. Finally, the form assembly is removed from a finished wall as shown in FIG. 17.

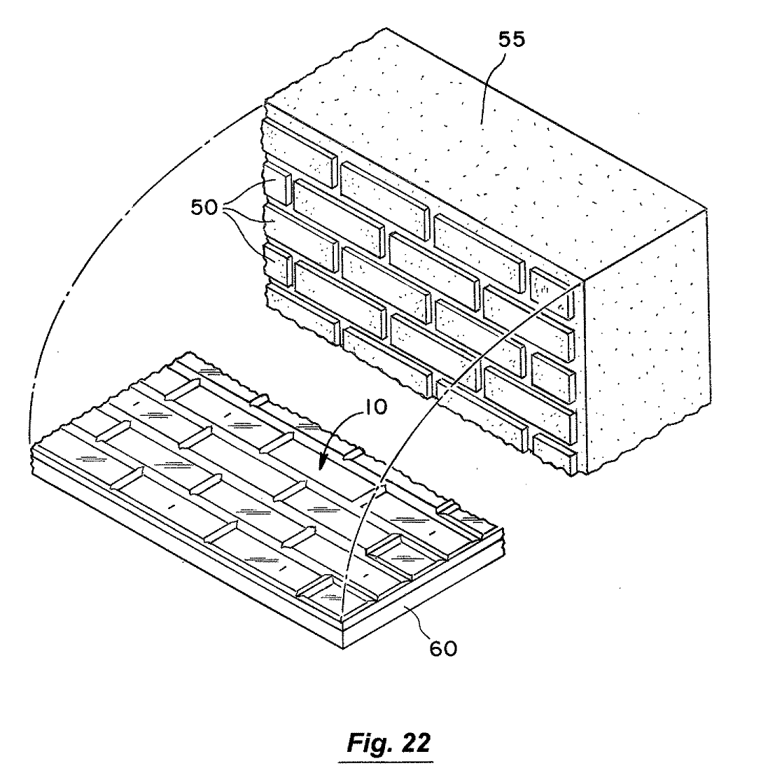

FIG. 18 is a front perspective view of another embodiment of a modular layout form 10 using an elastomeric rim 13 around the periphery of each receptacle 11 for holding bricks. FIG. 19 is a detail perspective view of a brick 50 being inserted into one of the receptacles 11 of the form 10. A corresponding detail cross-sectional view is provided in FIG. 20. FIG. 21 is a detail cross-sectional view of an assembled form and wall. Finally, FIG. 22 is a perspective view showing the form assembly being removed from a finished wall.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A modular layout form for embedding objects in a settable material comprising:
a substantially planar rear for attachment to a support structure;
a substantially planar front having a two-dimensional array of receptacles for holding a plurality of objects in a predetermined pattern having a plurality of courses staggered with respect to one another to define a pattern of recesses and protrusions at the ends of the courses; and
sets of tabs and slots on the recesses and protrusions for engaging complementary sets of tabs and slots on the recesses and protrusions of an adjacent form, whereby a plurality of forms can be combined by sliding adjacent forms together laterally in a common plane.

2. The modular layout form of claim 1 wherein the protrusions on an end of the form slidingly engage complementary recesses on an end of an adjacent form, and the recesses on the end of the form slidingly engage complementary protrusions on the end of the adjacent form.

3. The modular layout form of claim 1 wherein adjacent forms can alternatively be placed in abutment with their protrusions laterally aligned and their recesses laterally aligned, and further comprising a locking holder that can be inserted into the aligned recesses between adjacent forms, said locking holder having a substantially planar front with a receptacle for holding an object.

4. The modular layout form of claim 3 wherein the locking holder further comprises slots to engage the tabs extending into the aligned recesses of the forms.

5. The modular layout form of claim 1 wherein the tabs extend adjacent to the rear of the form.

6. The modular layout form of claim 5 wherein the protrusions further comprise horizontal channels in the rear of the form extending along the protrusions for sliding over tabs on the edges of the recesses of an adjacent form.

7. The modular layout form of claim 1 wherein the slots are formed in the edges of the protrusions and recesses adjacent to the rear of the form.

8. The modular layout form of claim 1 further comprising sets of tabs and slots on upper and lower edges of the form for engaging complementary sets of tabs and slots on the upper and lower edges of adjacent forms.

9. A modular layout form for embedding objects in a settable material comprising:
a substantially planar rear for attachment to a support structure;
a substantially planar front having a two-dimensional array of receptacles for holding a plurality of objects in a predetermined pattern having a plurality of courses staggered with respect to one another to define a pattern of recesses and protrusions at the ends of the courses with substantially horizontal edges;
sets of tabs and slots on the horizontal edges of the recesses and protrusions adjacent to the rear of the form for engaging complementary sets of tabs and slots on the recesses and protrusions of an adjacent form; and
horizontal channels in the rear of the protrusions for sliding over the tabs on the horizontal edges of the recesses of an adjacent form;
whereby a plurality of forms can be combined by sliding adjacent forms together laterally in a common plane with the protrusions on an end of the form slidingly engaging complementary recesses on an end of an adjacent form.

10. The modular layout form of claim 9 wherein adjacent forms can be placed in abutment with their protrusions laterally aligned and their recesses laterally aligned, and further comprising a locking holder that can be inserted into the aligned recesses between adjacent forms, said locking holder having a substantially planar front with a receptacle for holding an object.

11. The modular layout form of claim 10 wherein the locking holder further comprises slots to engage the tabs extending into the aligned recesses of the forms.

12. The modular layout form of claim 9 further comprising sets of tabs and slots on upper and lower edges of the form for engaging complementary sets of tabs and slots on the upper and lower edges of adjacent forms.

13. The modular layout form of claim 9 further comprising a holding having a substantially planar front with a receptacle for holding an object that can be inserted into a recess of a form.

14. A modular layout assembly for embedding objects in a settable material comprising:
a plurality of forms having:
(a) a substantially planar rear for attachment to a support structure;
(b) a substantially planar front having a two-dimensional array of receptacles for holding a plurality of objects in a predetermined pattern having a plurality of courses staggered with respect to one another to create lateral edges having a pattern of recesses and protrusions at the ends of the courses; and
(c) sets of tabs and slots on the recesses and protrusions for engaging complementary sets of tabs and slots on the recesses and protrusions of an adjacent form; and
a plurality of locking holders having a substantially planar front having a receptacle for holding an object;
whereby a plurality of forms can be selectively combined either; (a) by sliding adjacent forms together laterally in a common plane with the protrusions on an end of the form slidingly engaging complementary recesses on an end of an adjacent form; or (b) by aligning adjacent forms so that their protrusions abut and their recesses abut, and inserting locking holders into the abutting recesses of adjacent forms.

15. The modular layout form of claim 14 wherein the locking holders further comprise a set of slots for engaging complementary tabs on abutting recesses of adjacent forms.

16. The modular layout form of claim 14 wherein the protrusions further comprise horizontal channels in the rear of the form extending along the protrusions for sliding over tabs on the edges of the recesses of an adjacent form.

17. The modular layout form of claim 14 further comprising sets of tabs and slots on upper and lower edges of the forms for engaging complementary sets of tabs and slots on the upper and lower edges of adjacent forms.
